(19) United States
(12) Patent Application Publication
(10) Pub. No.: US 2004/0186703 A1
(43) Pub. Date: Sep. 23, 2004

(54) System and method for estimating power consumption for at least a portion of an integrated circuit

(76) Inventor: Rajakrishnan Radjassamy, Plano, TX (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/393,192

(22) Filed: Mar. 20, 2003

(51) Int. Cl. G06F 17/50

(52) U.S. Cl. 703/18

(57) ABSTRACT

A system and method for estimating power consumption of at least a portion of an integrated circuit (IC). The IC is segmented into a hierarchical sub-block level structure such that within each sub-block and between sub-blocks of the same level, power consumption components are identified so that the power consumption for each sub-block may be estimated based on an application of probabilistic activity profiles associated with the power consumption components.

### BACKGROUND

In previous decades, most logic design in integrated circuits (ICs) was preformed graphically using diagrams and schematics and verified by “breadboarding” the design. The increasing size, functionality and performance of ICs, time-to-market pressures, and cost constraints, however, have challenged traditional logic design. To provide ICs having increased input/output densities and complex, high pin-count packages in a constrained time period, IC logic design employs computer-aided design (CAD) software tools, also referred to as computer-aided engineering (CAE) software tools, to aid in the development of the conceptional and physical design of the IC as well as the verification of the IC.

Sophisticated CAD software tools contain component libraries and component models that describe in detail the logical and electrical operations of the digital system design of the IC. Using these models, the IC design may be verified so that various types of logic and timing errors may be found during the pre-silicon simulation phase of development. For example, design-rule checker modules may detect some of the more common errors in a design such as shorted outputs or floating inputs and, with the addition of input loading and output driving characteristics for each pin, the module can detect some of the more complicated errors such as exceeded fanout capability. Timing verification modules provide a tool that enables designers to determine the worst-case delay value for each input-to-output path, and setup and hold times for clocked devices so that the worst-case delay paths in the overall circuit may be determined. With this information, an experienced designer can determine if the timing margins are acceptable. Additionally, the component libraries and component models provided with the CAD software tools allow power simulator software modules to estimate the power consumed by the IC. Typically, these modules are capable of calculating average or peak power consumption for the design with or without using a predetermined heuristic factor such as the “toggle factor.”

Notwithstanding these advantages, however, several limitations and drawbacks continue to persist with respect to the state-of-the art IC design software tools. Inasmuch as power consumption estimation is a critical factor in the IC design, the existing toggle factor approach for estimating the power consumption of the IC can give rise to misleading results if the heuristic factors used in the estimation are inaccurate. Depending on the type of power estimation tool, be it analytical or simulation-based, the degree of accuracy and the limitations inherent therein will vary. One of the significant limitations may be the inability to determine the power consumed by a portion of the IC design, thereby completely missing out a potential “hot spot” that is localized in the design.

### SUMMARY

A system and method for estimating power consumption of at least a portion of an integrated circuit (IC) design is disclosed. In one embodiment, the IC is segmented into a hierarchical sub-block level structure such that within each sub-block and between sub-blocks of the same level, power consumption components are identified. Power consumption for each sub-block is estimated based on an application of probabilistic activity profiles associated with the power consumption components.

### BRIEF DESCRIPTION OF THE DRAWINGS

FIG. 1 depicts a hierarchical schematic structure with respect to a digital integrated circuit (IC) design employing a system for estimating power consumption of at least a portion of the IC;

FIG. 2 depicts a functional block diagram illustrating an embodiment of a system for estimating the power consumption of a portion of the IC;

FIG. 3 depicts a flow chart illustrating an embodiment of a method for estimating power consumption of at least a portion of the IC;

FIG. 4 depicts a schematic diagram of an exemplary sub-block for which the system for estimating power consumption of at least a portion of the IC is employed;

FIG. 5A depicts a schematic diagram of one embodiment of a pad driver/receiver model that is contained within the sub-block of FIG. 4;

FIG. 5B depicts a schematic diagram of one embodiment of a clock circuit model that is contained within the sub-block of FIG. 4;

FIG. 5C depicts a schematic diagram of one embodiment of a flip-flop model that is contained within the sub-block of FIG. 4;

FIG. 5D depicts a schematic diagram of one embodiment of a gate model that is contained within the sub-block of FIG. 4;

FIG. 5E depicts a schematic diagram of one embodiment of a latch array model that is contained within the sub-block of FIG. 4; and

FIG. 5F depicts a schematic diagram of one embodiment of a repeater model that is contained within the sub-block of FIG. 4.

### DETAILED DESCRIPTION OF THE DRAWINGS

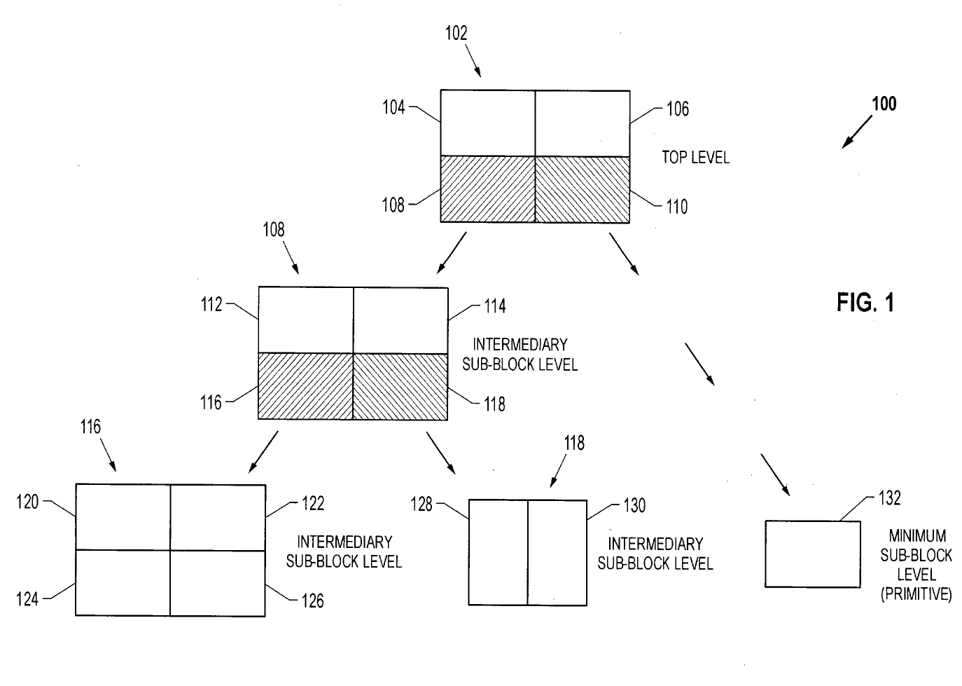

In the drawings, like or similar elements are designated with identical reference numerals throughout the several views thereof, and the various elements depicted are not necessarily drawn to scale. Referring now to FIG. 1, depicted therein is an embodiment of a hierarchical schematic structure 100 of a digital integrated circuit (IC) design which is employed by a system for estimating power consumption of at least a portion of the IC in accordance with the teachings herein. The hierarchical schematic structure 100 may be designed using a schematic editor in a highly capable hardware-description language (HDL) environment such as a Very High Speed Integrated Circuit (VHSIC) hardware description language (VHDL) environment, a Verilog description language environment, or an Advanced Boolean Equation Language (ABEL) environment, for example. The HDL language environment provides a design, simulation, and synthesis platform wherein a top level design may be decomposed hierarchically and each constituent component within the design can be provided with both a well-defined interface for connecting it to other components and a precise behavioral specification that enables simulation.

A top level structure 102 includes four sub-blocks 104, 106, 108, and 110 that define the system-level description of the IC. Each sub-block 104, 106, 108, and 110 may depict subsystem-level descriptions, component-level descriptions, or combination subsystem-component-level descriptions of the IC. Although the top level structure 102 is depicted as containing four sub-blocks, it should be appreciated that the top level structure and the sub-structures of the top level structure may have any number of sub-blocks. As illustrated, sub-block 108, an intermediary sub-block level, comprises four sub-blocks 112, 114, 116, and 118. Sub-block 116, in turn may be decomposed into another intermediary sub-block level that includes sub-blocks 120, 122, 124, and 126. Additionally, sub-block 118, an intermediary sub-block, may be decomposed into sub-blocks 128 and 130. The hierarchical decomposition of the top level structure 102 may continue until a sub-block is divided into a minimum sub-block level called a “primitive.” For example, as illustrated by the series of arrows, sub-block 110 has been decomposed into a minimum sub-block level that includes sub-block 132. Similar to sub-blocks 104-110, sub-blocks 112-132 may each include subsystem-level descriptions, component-level descriptions, or combination subsystem component-level descriptions of the IC. In addition, sub-block 132, a minimum sub-block level, may include a primitive cell description that illustrates the circuit in terms of relationships between gates, sources, and devices, for example. As will be described in further detail hereinbelow, the system for estimating the power consumption of at least a portion of the IC may determine the power consumption of a particular sub-block of the IC at any hierarchical level or the power consumption of the entire IC. For example, the system may be employed to estimate the power consumption of the top level structure 102, intermediary sub-block level structure 108, or minimum sub-block level structure 132.

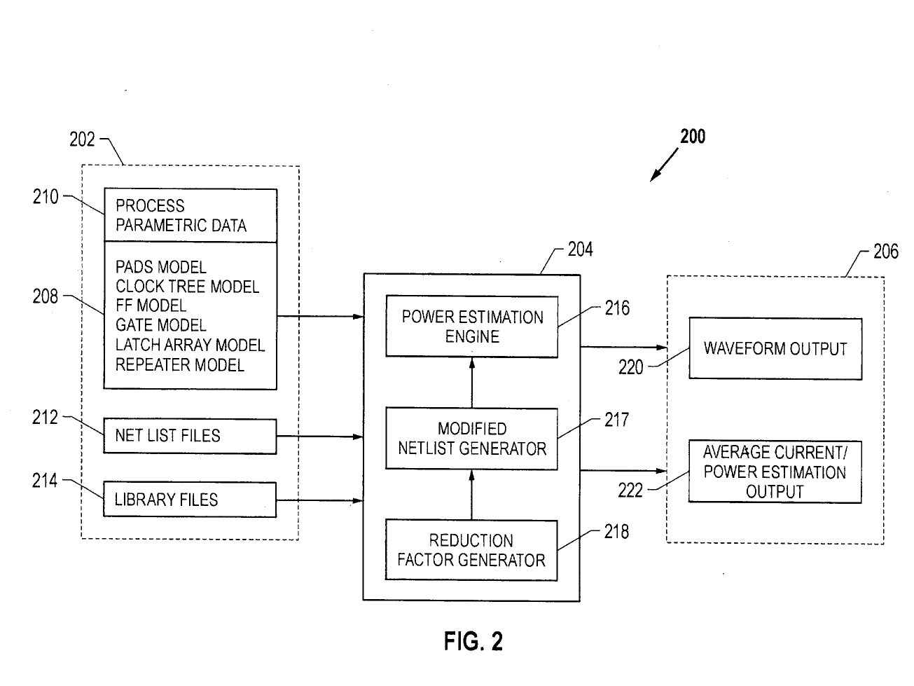

FIG. 2 depicts an embodiment of a system 200 for estimating the power consumption of a portion of the IC. The system 200 may be employed with any type of IC, including Application-Specific ICs (ASICs) and Field Programmable Gate Arrays (FPGAs), and with any type of fabrication process such as Complementary Metal-oxide Semiconductor (CMOS) fabrication processes. Moreover, the system 200 may be employed to estimate the power consumption at any hierarchical level of IC design. For example, the system 200 may be employed at the minimum sub-block level 132 of FIG. 1, the top level 102 of FIG. 1, or at any level therebetween. Various design simulation files 202 are provided as an input with respect to a power estimation tool 204 which produces power estimation output 206. The design simulation files 202 are created by a schematic editor during the early stages of a computer-aided logic design process in order to describe the IC device's logical and electrical operation at different hierarchical levels so as to afford a fine-grain power consumption modeling. Schematic editors produce various data and file types, such as model files 208, process parametric data 210, and netlist files 212, for example, to simplify both the entry and retrieval of information stored in a hierarchical schematic structure such as the hierarchical structure presented in FIG. 1. Specifically, the model files 208 represent the connectivity and other features of the primitive and library components of the IC design. The process parametric data 210 may comprise process-related information necessary for simulating different devices used in the design. By way of example, for P-channel and N-channel MOSFET devices, such information includes channel length and width parameters, gate oxide thickness, capacitances, et cetera. The netlist files 212 specify the connections between nets, i.e., sets of pins that are all connected to the same electrical node or signal, that are required by the schematic. In one embodiment, the netlist files 212 comprise level-specific information that includes connection data for the top-level, intermediary sub-block levels, minimum sub-block levels, and device-levels of the IC. Typically, the connections described by the netlist files 212 may be expressed as an alphabetical sorted list of signal names where, for each signal name, the reference designator and pin number of a device pin and connection signal position are provided. Library files 214 provide the component manufacturing documentation for the component type reference designations and include information relative to standard cells and gate arrays, for example. It should be appreciated that the design simulation files may include other files required to describe the logical and electrical operation of a particular IC design.

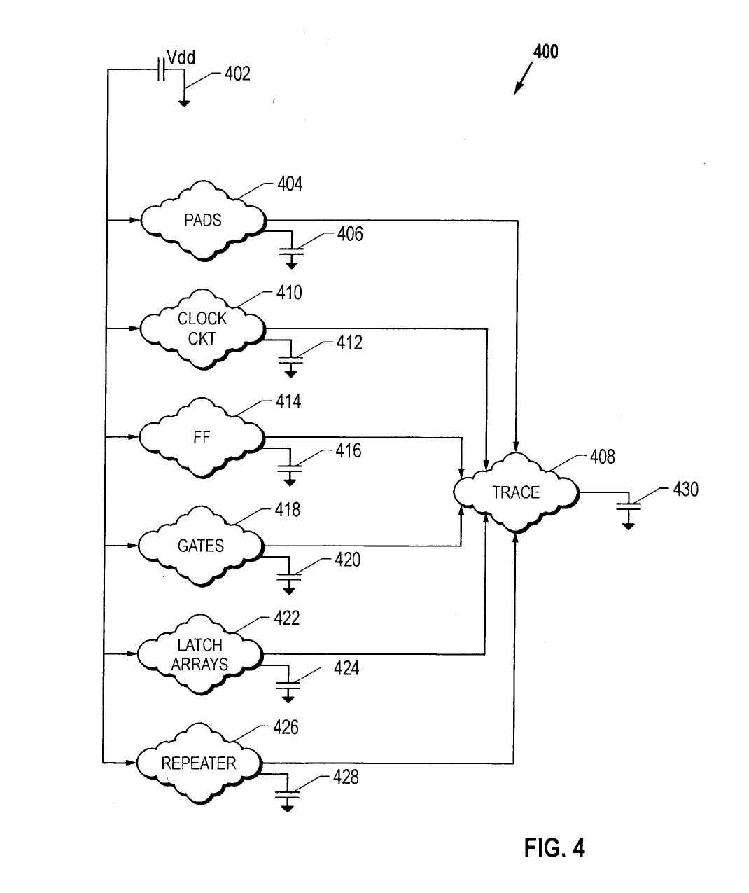

The power estimation tool 204 includes a power estimation engine 216, a modified netlist generator 217 and a reduction factor generator 218. The power estimation engine 216 employs the hierarchical schematic IC structure provided by the design simulation files 202 to determine the power consumption components within each sub-block structure of the IC design and between sub-blocks of the same level such that the power estimation tool 204 may be employed to estimate the power consumption at the circuit level of the entire IC or a portion thereof. In one embodiment, the power estimation engine 216 may comprise a software simulation tool known in the art such as a Simulated Program with Integrated Circuit Emphasis (SPICE) that employs various mathematical models to estimate the power consumption. The reduction factor generator 218 determines a reduction factor for each power consumption component of each sub-block level of interest. As will be explained in more detail hereinbelow, the reduction factor represents a composite probabilistic activity profile associated with each power consumption component that is based on its structural, functional, design and process constraints. Using the reduction factors for each sub-block, sub-block level, or portion of the IC of interest, the modified netlist generator 217 provides a modified netlist that uses a reduced number of components (e.g., FETs, flip-flops, and the like) to model the portion of the IC of interest as illustrated in further detail in FIG. 4 hereinbelow. Subsequently, the power estimation engine 216 estimates the power consumption based on the modified netlists at the appropriate circuit level, which is essentially a function of a power factor that is modulated by the reduction factors. The power consumption estimate may be used to generate a waveform output 220 or an average current/power estimation output 222, for example. The power estimation tool 204 and system described herein may be incorporated into any existing simulation environment to provide pre-silicon design phase power estimations. This flexibility enables an IC designer to consider the activity of signals at different blocks or levels of the IC in order to diagnose and isolate hot spots within the IC design that consume large amounts of power.

For example, with reference to FIG. 1 and FIG. 2, in order to estimate the power consumption of intermediary sub-block level 108, the modified netlist generator 217 acquires the design simulation files 202 that describe the constituent components of blocks 112-118 which form intermediary sub-block level 108. The modified netlist generator 217 produces models, such as the models described hereinbelow in FIG. 4, of the power consumption components of the blocks 112-118 that describe the power consumption with each block and between the blocks 112-118. The power estimation engine estimates the power consumption of each component with a reduction factor produced by the reduction factor generator 218. The power estimation values of the power consumption components of blocks 112-188 are then aggregated to provide an estimate of the power consumption of the intermediary sub-block level 108.

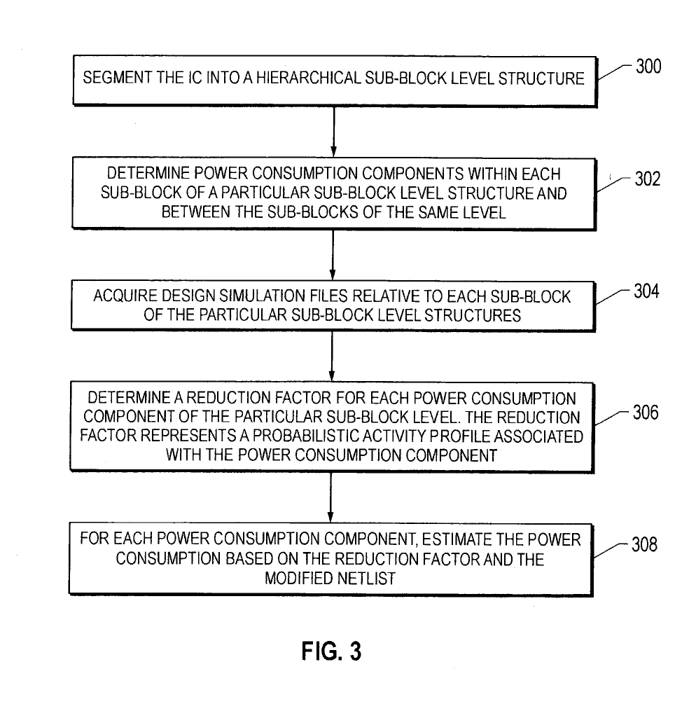

FIG. 3 illustrates an embodiment of a method for estimating power consumption of at least a portion of the IC. At block 300, the IC design is segmented into a hierarchical sub-block level structure that may comprise any number of levels having any number of sub-block structures. For example, with reference to FIG. 1, the IC design 100 may be segmented into a block structure that includes blocks 104, 106, 108 and 110. At block 302, power consumption components are determined and characterized within each sub-block of a particular sub-block level structure and between the sub-blocks of the same level. At block 304, design simulation files are acquired relative to each sub-block of the particular sub-block level structure. For example, the modified netlist generator 217 of FIG. 2 acquires the design simulation files 202 which describe the components and component connections of the sub-block of interest in order to model the power consumption components of the sub-block of interest.

At block 306, a reduction factor is determined for each power consumption component of the particular sub-block level. As will be explained in further detail hereinbelow, the reduction factor may represent a composite probabilistic activity profile associated with the power consumption component. At block 308, for each power consumption component, the power consumption is estimated as a function of a raw power factor and the reduction factor. It should therefore be appreciated that the embodiment described herein provides for a modular, simulation based method of estimating power consumption that estimates power for a particular sub-block or sub-blocks of interest by analyzing relevant sub-block power consumption components. Accordingly, the modular fine-grain approach described herein is able to provide an accurate and scalable estimate of power consumption.

FIG. 4 depicts an exemplary sub-block 400 of an IC design for which the system for estimating power consumption of at least a portion of the IC may be employed to estimate power. By way of example, referring to IC design 100 of FIG. 1, sub-block 400 is an aggregated representative of the circuit design portion at any hierarchical level, such as sub-blocks 104, 106, 108 and 110 or sub-blocks 112, 114, 116 and 118 of intermediary level, or sub-blocks 128 and 130 of another intermediary level, and the like. Accordingly, the sub-block 400 includes various power consuming components thereof that are supplied power by power source 402. The modified netlist generator 217 of FIG. 2 employs the various design simulation files 202 to produce a model of the portion of the IC of interest. It should be appreciated that the particular sub-block of interest may have all or a portion of the models described hereinbelow. Pad module 404 represents the power consuming pad components of the sub-block or portion of the IC of interest that provide external connectivity. In particular, the pad module 404 may represent both driver and receiver pads that perform outputting and inputting functions. As an aggregate model, the pad module 404 is grounded by a ground and interfaces with a trace module 408 that is representative of all trace/interconnect elements of the sub-block 400. Parasitic capacitance associated with the pads is modeled as a capacitor 406. By way of example, as a part of estimating the power consumption of block 114 of FIG. 1, the power estimation tool 204 of FIG. 2 may acquire the design simulation files 202 that describe the components and component connections of block 114. Power consuming components, such as the pads, are then modeled and the power consumption for the pads is determined. The power estimation of the pads may be aggregated with other power consumption component estimates in estimating the power of the block 114.

Clock circuit module 410 represents the power consumption of the circuits of a clock tree that are required to generate a series of high and low pulses at a fixed frequency in order to generate a free-running clock signal. Similar to the pad module 404, the clock circuit module 410 is grounded via capacitance 412 and interfaces with trace module 408. A flip-flop module 414 represents the power consumption of the flip-flop sequential devices that sample their inputs and change their outputs at times determined by the free-running clock signal. A capacitance 416 is connected to the flip-flop module 414 which interfaces with trace module 408.

A gate module 418 which is grounded via capacitance 420 represents the combinational circuitry of the sub-block 400. A latch array module 422 is grounded via capacitance 424 and represents the power consumption of the latch sequential devices of the sub-block 400. A repeater module 426 grounded via capacitance 428 represents the power consumption of the repeating devices (e.g., buffers) within the sub-block level 400. As with the other modules, gate module 418, latch array module 422, and repeater module 426 interface with the trace module 428. Also, as pointed out earlier, the trace module 428 represents the power consumption of interconnections of the sub-block level structure 400 and is grounded via capacitance 430. It should be appreciated that although certain sub-block modules are specifically depicted for purposes of explaining certain concepts presented herein, other sub-block modular descriptions of the sub-block level may also be employed and will be obvious to those with ordinary skill in the art upon reading this disclosure.

After the IC has been decomposed into the sub-block level or levels of interest as previously illustrated in FIG. 1 and the power consuming components within the sub-block level of interest and between sub-blocks within the level of interest have been identified as previously illustrated in FIG. 4, the power estimation tool 204 of FIG. 2 may estimate the power consumption by examining the particular power consuming components and performing an estimate of power consumption. The power consumption may be estimated by way of one or more equations that include a raw power factor and a reduction factor for each power consumption component that is representative of a probabilistic activity profile associated with the power consumption component. As previously alluded to, the probabilistic activity profile may comprise at least one activity factor that may take the form of a correction coefficient that is based on either the power consumption component's structural constraints, functional constraints, design constraints, process constraints, or some combination thereof. Accordingly, the reduction factor generator 218 employs one or more power consumption component's constraints to arrive at an activity factor profile for the component that represents the probabilistic reality of the way its circuitry is designed to operate under normal conditions. The reduction factor is then applied in conjunction with the netlist files associated with the aggregated power consumption component to derive a modified netlist using the modified netlist generator 217. As will be set forth below, the power estimation engine 216 is operable to estimate power consumption of the constituent components by employing current flow estimation equations that are based on the modified netlists of the component models.

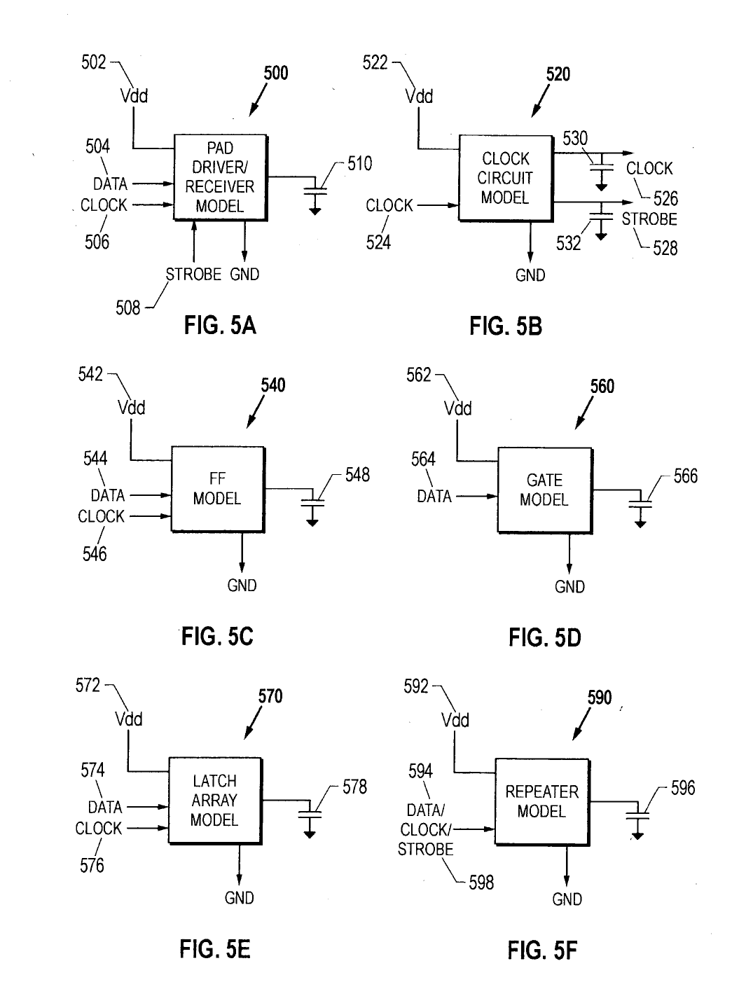

FIG. 5A illustrates one embodiment of a power consuming component, a pad model 500, that is representative of the pad component 404 contained within the sub-block of FIG. 4. A power input 502, a data input 504, a clock input 506, and a strobe input 508 provide input to the pad model 500 that is coupled to an interconnect trace capacitance 510. To estimate the power consumption of the pads by the pad model 500, the design simulation files for each type of pad, including both driver and receiver pads, are acquired. With the data provided by the design simulation files, power may be estimated for the pads. In one embodiment, the following equations may be employed by the power estimation engine 216 of the tool 204 of FIG. 2 to estimate the power consumption of the pads:

P_{EST}=I_{EST}V

$${I}_{EST} = {\sum }_{i = 1}^{N} ( {I}_{i} {D}_{i} F ) + ( {I}_{i} {R}_{i} F )$$

wherein P_{EST} represents the estimate of power consumption;

I_{EST} represents the estimate of current;

V represents voltage;

Iᵢ represents the current for pad type i;

N represents the maximum number of pad types;

Dᵢ represents a driver pad of type i;

Rᵢ represents a receiver pad of type i; and

F represents the reduction factor for the pads.

The equations represent an estimation of the power consumption of the pads produced by multiplying the voltage by the current, i.e., a raw power component, for each type of pad by the number of pads of that particular type and a reduction factor which corrects the raw power component. The reduction factor is based on an activity factor for the pads which represents the receiving and driving signal relationships of the pads. In one embodiment, the reduction factor may be 0.5 since at any given moment, half of the pads are receiving a signal and half of the pads are driving a signal.

FIG. 5B depicts one embodiment of a clock circuit model 520 that is representative of the clock module 410 of the sub-block of FIG. 4. A power signal 522 and a free-running clock signal 524 provide input to the clock circuit model 520 which outputs a clock signal 526 and a strobe signal 528 used for data signal timing. Capacitance associated with these two signal outputs are modeled by capacitors 530 and 532. In order to estimate the power consumption for the clock circuit model 520, the design simulation files for the clock circuit tree are acquired. Similar to the pad model discussed hereinbelow, with the data provided by the design simulation files, power may be estimated for the clock model 520. In one embodiment, the following equations may be employed by the power estimation tool 204 in estimating the power consumption of the clock model 520:

P_{EST}=I_{EST}V

$${I}_{EST} = {\sum }_{i = 1}^{N} {B}_{i} {I}_{i} F$$

wherein P_{EST} represents the estimate of power consumption;

I_{EST} represents the estimate of current;

V represents voltage;

Bᵢ represents the number of clocks of clock type i in the clock tree of the sub-block;

N represents the maximum number of types of clocks;

Iᵢ represents the current of clock type i; and

F represents the reduction factor for the clock.

The reduction factor is based on the level-specific activity profiles of the clock which take into account clock characteristics such as clock period/clock frequency, clock tick and duty cycle, for example.

FIG. 5C illustrates one embodiment of a flip-flop model 540 for modeling the flip-flop module 414 that is contained within the sub-block of FIG. 4. A power signal 542, data signal 544, and a clock signal 546 provide inputs to the flip-flop model that is coupled to an interconnect trace capacitance 548. Again, the design simulation files for the flip-flops are acquired to estimate the power consumption for the sequential flip-flops. In one embodiment, the following equations may be employed in estimating the power consumption of the flip-flop model 540:

P_{EST}=I_{EST}V

$${I}_{EST} = {\sum }_{i = 1}^{N} {I}_{i} {P}_{i} F$$

wherein P_{EST} represents the estimate of power consumption;

I_{EST} represents the estimate of current;

V represents voltage;

Pᵢ represents the number of flip-flops of type i in the sub-block;

N represents the maximum number of types of flip-flops;

Iᵢ represents the current of flip-flop type i; and

F represents the reduction factor for the flip-flops.

In the instant equation, the raw power component (IᵢPᵢ) represents the worst-case power consumption for a given voltage (V). The reduction factor incorporates design-based activity profiles of the flip-flops and may represent a coefficient between 0 and 1 that corrects the worst-case power by taking into considerations such as clock toggling rate and flip-flop toggling rates.

FIG. 5D depicts one embodiment of a gate model 560 for modeling the gate module 418 that is contained within the sub-block of FIG. 4. A power signal 562 and a data signal 564 provide inputs to gate model 560 that is coupled to an interconnect trace capacitance 566. As previously discussed, by acquiring the design simulation files of the gates of the particular sub-block level or levels of interest, the power consumption for the gate model 560 may be estimated. In one embodiment, the following equations may be employed in estimating the power consumption of the gate model 560:

P_{EST}=I_{EST}V

$${I}_{EST} = {\sum }_{x = 1}^{M} {\sum }_{y = 1}^{N} {i}_{y} {c}_{y} F$$

wherein P_{EST} represents the estimate of power consumption;

I_{EST} represents the estimate of current;

V represents voltage;

i_{y} is the gate current for gate type y;

c_{Y} is the count or number of type y gates at level x;

F=AₓA_{y} where F is the reduction factor and Aₓ is the activity factor for a particular gate at level x and A_{y} is the activity factor for the particular gate of type y;

M represents the maximum number of gate levels; and

N represents the maximum number of gate types.

In one embodiment, by employing the linear combination of equations presented above, the activity factors for the particular gate model may be calculated by working under the assumption that not all of the gates change state or toggle at the same time. By examining the logic chain of the gate model and the complexity of the combinational logic therein, a probabilistic profile of gate toggling may be calculated and employed in the power consumption calculations.

FIG. 5E illustrates one embodiment of a latch array model 570 that is representative of the latch array module 422 contained within the sub-block of FIG. 4. A power signal 572, a data signal 574, and a clock signal 576 provide inputs to the latch array model 570 which is coupled to an interconnect trace capacitance 578. By acquiring the design simulation files relevant to the particular latch array model 570, in one embodiment, the following equations may be employed in estimating the power consumption of the latch array model 570:

P_{EST}=I_{EST}V

I_{EST}=WDiF

wherein P_{EST} represents the estimate of power consumption;

I_{EST} represents the estimate of current;

V represents the voltage;

W is the width of the latch array;

D is the depth of the latch array;

i is the current for a single latch; and

F is the reduction factor associated with the latch array.

For this equation, the reduction factor may be based on a probabilistic activity profile comprising activity factors that characterize the particular component constraints such as the particular inputs and assertions of the latch array.

FIG. 5F illustrates one embodiment of a repeater model 590 for modeling the repeater module 426 of the sub-block shown in FIG. 4. A power signal 592 and a data signal 594 provide input to the repeater model 590. In addition, a timing signal 598 (which may also be a clock signal or a strobe signal) may be provided to the repeater model 590 that is coupled to an interconnect trace capacitor 596. Based on the design simulation files, in one embodiment, the following equations may be employed in estimating the power consumption of the repeater model 590:

PEST=I_{EST}V

$${I}_{EST} = {\sum }_{i = 1}^{N} {R}_{i} {I}_{i} F$$

wherein P_{EST} represents the estimate of power consumption;

I_{EST} represents the estimate of current;

V represents voltage;

Rᵢ represents the number of repeaters of type i present;

N represents the maximum number of types of repeaters present;

Iᵢ represents the current of repeaters of type i; and

F represents the reduction factor for the repeaters.

In this example, the raw power factor (the V in P_{EST} equation multiplied by the RᵢIᵢ in the I_{EST} equation) is representative of the worst-case or maximum power consumption for a particular voltage which is adjusted by the reduction factor. Again, the reduction factor may be based on a probabilistic activity profile comprising activity factors that take into account the logic behavior of the particular repeater model 590 of interest. Upon estimating the power consumption of each component of a particular sub-block, the power consumption of the entire sub-block may be estimated by aggregating the power consumption estimates of its constituent power consuming components. Analogously, the power consumption of a particular higher-order sub-block level or larger portion of the IC may be estimated by suitably aggregating the power consumption of its constituent sub-block levels and power consumption components. The power estimation may be provided as a waveform output 220 of FIG. 2 or an average current/power estimation output 222 of FIG. 2. Accordingly, it should be appreciated that the systems and methods described herein are able to provide a comprehensive and scalable tool for estimating the power consumption of an entire IC or a portion thereof.

Although a particular description with reference to certain illustrations has been presented, it is to be understood that the forms shown and described herein are to be treated as exemplary embodiments only. Various changes, substitutions and modifications can be realized without departing from the spirit and scope of the invention as defined by the appended claims.

What is claimed is:

1. A method for estimating power consumption of at least a portion of an integrated circuit (IC), comprising:
segmenting a design of said IC into a hierarchical sub-block level structure;
determining power consumption components within each sub-block of a particular sub-block level structure;
acquiring design simulation files relative to each sub-block of said particular sub-block level structure;
determining a reduction factor for each power consumption component of said particular sub-block level, wherein said reduction factor is representative of a probabilistic activity profile associated with said power consumption component; and
for each power consumption component, estimating its power consumption based on a modified netlist derived for said each power consumption component using its reduction factor.

2. The method as recited in claim 1, wherein said power consumption components are selected from the group consisting of pads, clocks, flip-flops, gates, latch arrays, repeaters, and signal traces.

3. The method as recited in claim 1, wherein said design simulation files are selected from the group consisting of process files, library files, and netlist files.

4. The method as recited in claim 1, wherein said operation of determining power consumption components comprises determining power consumption components within each sub-block of a particular sub-block level structure and between said sub-blocks of the same level.

5. The method as recited in claim 1, wherein said probabilistic activity profile comprises at least one activity factor that is based on structural constraints associated with said power consumption components.

6. The method as recited in claim 1, wherein said probabilistic activity profile comprises at least one activity factor that is based on functional constraints associated with said power consumption components.

7. The method as recited in claim 1, wherein said probabilistic activity profile comprises at least one activity factor that is based on design constraints associated with said power consumption components.

8. The method as recited in claim 1, wherein said probabilistic activity profile comprises at least one activity factor that is based on process constraints associated with said power consumption components.

9. The method as recited in claim 1, further comprising aggregating said power consumption estimate for each sub-block to calculate a power consumption estimate for said IC.

10. A system for estimating the power consumption of at least a portion of an integrated circuit (IC), comprising:
means for segmenting a design of said IC into a hierarchical sub-block level structure; and
means for estimating power consumption for each sub-block based on application of probabilistic activity profiles associated with power consumption components of said sub-blocks.

11. The system as recited in claim 10, further comprising means for acquiring design simulation files relative to each said sub-block and its constituent power consumption components.

12. The system as recited in claim 10, wherein said power consumption components are selected from the group consisting of pads, clocks, flip-flops, gates, latch arrays, repeaters, and signal traces.

13. The system as recited in claim 10, wherein each of said probabilistic activity profiles comprises at least one activity factor that is based on structural constraints associated with a particular power consumption component.

14. The system as recited in claim 10, wherein each of said probabilistic activity profiles comprises at least one activity factor that is based on functional constraints associated with a particular power consumption component.

15. The system as recited in claim 10, wherein each of said probabilistic activity profiles comprises at least one activity factor that is based on design constraints associated with a particular power consumption component.

16. The system as recited in claim 10, wherein each of said probabilistic activity profiles comprises at least one activity factor that is based on process constraints associated with a particular power consumption component.

17. A computer-readable medium operable with a computer platform to estimate power consumption of at least a portion of an integrated circuit (IC), the medium having stored thereon:
instructions for segmenting a design of said IC into a hierarchical sub-block level structure;
instructions for determining power consumption components within each sub-block of a particular sub-block level structure;
instructions for acquiring design simulation files relative to each sub-block of said particular sub-block level structure;
instructions for determining a reduction factor for each power consumption component of said particular sub-block level, wherein said reduction factor is representative of a probabilistic activity profile associated with said power consumption component; and
instructions for estimating power consumption of each constituent component based on a modified netlist derived for said each constituent component using its reduction factor.

18. The computer-readable medium as recited in claim 17, wherein said power consumption components are selected from the group consisting of pads, clocks, flip-flops, gates, latch arrays, repeaters, and signal traces.

19. The computer-readable medium as recited in claim 17, wherein said instructions for acquiring design simulation files are associated with a simulator operable with said computer platform.

20. The computer-readable medium as recited in claim 17, wherein said instructions for determining power consumption components comprise instructions for determining power consumption components within each sub-block of a particular sub-block level structure and between said sub-blocks of the same level;

21. The computer-readable medium as recited in claim 17, wherein said probabilistic activity profile comprises at least one activity factor that is based on structural constraints associated with a particular power consumption component.

22. The computer-readable medium as recited in claim 17, wherein said probabilistic activity profile comprises at least one activity factor that is based on functional constraints associated with a particular power consumption component.

23. The computer-readable medium as recited in claim 17, wherein said probabilistic activity profile comprises at least one activity factor that is based on design constraints associated with a particular power consumption component.

24. The computer-readable medium as recited in claim 17, wherein said probabilistic activity profile comprises at least one activity factor that is based on process constraints associated with a particular power consumption component.

25. A method for estimating power consumption of at least a portion of an integrated circuit (IC) comprising:
segmenting said IC into a hierarchical sub-block level structure such that within each sub-block and between sub-blocks of the same level, power consumption components are identified; and
estimating the power consumed for each sub-block based on application of probabilistic activity profiles associated with said power consumption components.
